(19) United States
(12) Patent Application Publication
(10) Pub. No.: US 2025/0244940 A1
(43) Pub. Date: Jul. 31, 2025

(54) COUPLING STATE DETECTION METHOD, DISPLAY SYSTEM, AND DISPLAY DEVICE

(71) Applicant: SEIKO EPSON CORPORATION, Tokyo (JP)

(72) Inventors: Kazumi YOSHIZAWA, Matsumoto-shi (JP); Naoki ISHII, Matsumoto-shi (JP)

(73) Assignee: SEIKO EPSON CORPORATION, Tokyo (JP)

(21) Appl. No.: 19/040,349

(22) Filed: Jan. 29, 2025

(30) Foreign Application Priority Data
Jan. 30, 2024 (JP) 2024-012266

(51) Int. Cl. G06F 3/14

(52) U.S. Cl. CPC G06F 3/1423

(57) ABSTRACT

A coupling state detection method includes, when a coupling confirmation signal from an information processing device coupled to a projector including a first I/F and a second I/F is received via a preset interface among the first I/F and the second I/F, transmitting a first response signal from the preset interface.

The present application is based on, and claims priority from JP Application Serial Number 2024-012266, filed Jan. 30, 2024, the disclosure of which is hereby incorporated by reference herein in its entirety.

### BACKGROUND

### 1. Technical Field

The present disclosure relates to a coupling state detection method, a display system, and a display device.

### 2. Related Art

In the related art, a display device is capable of coupling image output devices to a plurality of interfaces provided in the display device.

For example, JP-A-2015-75716 discloses a video display device including a video generation unit that generates a video, a first video signal input unit, a second video signal input unit, and a control unit that controls the video generation unit based on a video signal from the first video signal input unit or the second video signal input unit.

In a system configuration disclosed in JP-A-2015-75716, for example, when a correspondence between an interface provided in the display device and an image output device to be coupled to the interface is set in advance, the image output device may be coupled to the display device in an incorrect correspondence.

### SUMMARY

The present disclosure provides a coupling state detection method including, when a coupling confirmation signal from an image output device coupled to a display device including a first interface and a second interface is received via a preset interface among the first interface and the second interface, transmitting a first response signal from the preset interface.

The preset disclosure provides a display system including: a display device including a first interface and a second interface; and a first image output device coupled to the display device and configured to transmit a coupling confirmation signal to the display device. When the coupling confirmation signal is received from a preset interface among the first interface and the second interface, the display device transmits a first response signal from the preset interface.

The preset disclosure provides a display device including: a first interface and a second interface; and at least one processor. When a coupling confirmation signal is received via a preset interface among the first interface and the second interface, the at least one processor transmits a first response signal via the preset interface.

### BRIEF DESCRIPTION OF THE DRAWINGS

FIG. 1 is a diagram showing a system configuration of a display system.

FIG. 2 is a block diagram showing a configuration of an information processing device.

FIG. 3 is a block diagram showing a configuration of a projector.

FIG. 4 is a diagram showing an example of a guidane image displayed on a display unit.

FIG. 5 is a diagram showing an example of the guidane image displayed on the display unit.

FIG. 6 is a flowchart showing an operation of the information processing device according to a first embodiment.

FIG. 7 is a flowchart showing an operation of the projector according to the first embodiment.

FIG. 8 is a flowchart showing an operation of a projector according to a second embodiment.

FIG. 9 is a flowchart showing an operation of an information processing device according to a third embodiment.

FIG. 10 is a diagram showing an example of the guidane image displayed on a projection surface.

FIG. 11 is a diagram showing an example of the guidane image displayed on the projection surface.

### DESCRIPTION OF EMBODIMENTS

### 1. System Configuration in First Embodiment

Hereinafter, embodiments will be described with reference to the drawings.

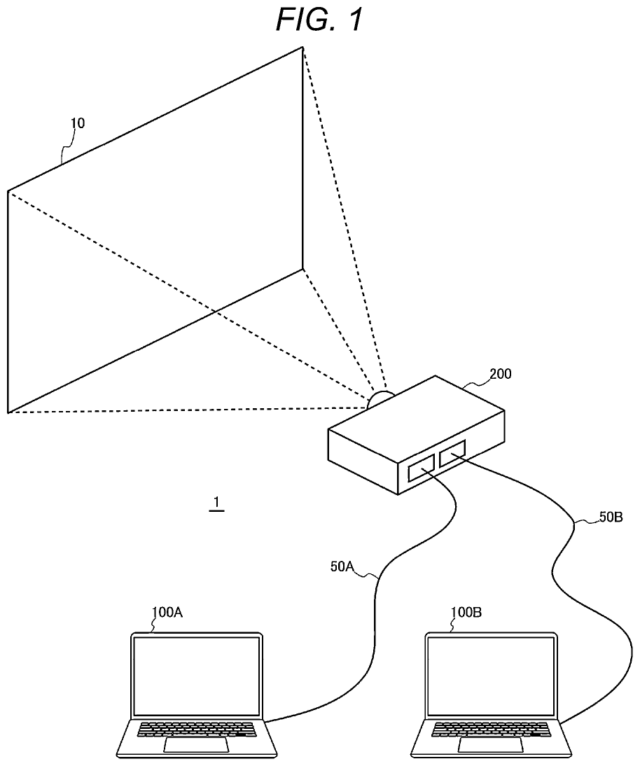

FIG. 1 shows a system configuration of a display system 1.

The display system 1 includes an information processing device 100 and a projector 200. The information processing device 100 corresponds to an image output device, and the projector 200 corresponds to a display device.

Although FIG. 1 shows a case in which the display system 1 includes two information processing devices 100A and 100B, the number of information processing devices 100 provided in the display system 1 is freely set, and may be one or three or more. Although FIG. 1 shows a case in which the display system 1 includes one projector 200, the number of projectors 200 provided in the display system 1 is freely set, and may be two or more. In addition, although FIG. 1 shows a case in which two information processing devices 100A and 100B are coupled to the projector 200, the number of information processing devices 100 coupled to the projector 200 is also freely set. Hereinafter, the information processing devices 100A and 100B are collectively referred to as the information processing device 100. The information processing device 100A corresponds to an image output device and a first image output device, and the information processing device 100B corresponds to the image output device and a second image output device.

The information processing device 100A is wire-coupled to the projector 200 via a cable 50A, and the information processing device 100B is wire-coupled to the projector 200 via a cable 50B. In the embodiment, a case in which the cable 50A and the cable 50B are high-definition multimedia interface (HDMI) cables will be described. HDMI is a registered trademark.

The information processing device 100 supplies image data to the projector 200. The image that is a source of the image data supplied by the information processing device 100 may be a moving image or a still image. As the information processing device 100, for example, a personal computer such as a desktop personal computer, a notebook personal computer, or a tablet personal computer is used. A mobile terminal such as a smartphone may be used as the information processing device 100.

The projector 200 generates image light based on the image data supplied from the information processing device 100, and enlarges and projects the generated image light onto the projection surface 10. Accordingly, an image corresponding to the image light is displayed on a projection surface 10.

### 2. Configuration of Information Processing Device in First Embodiment

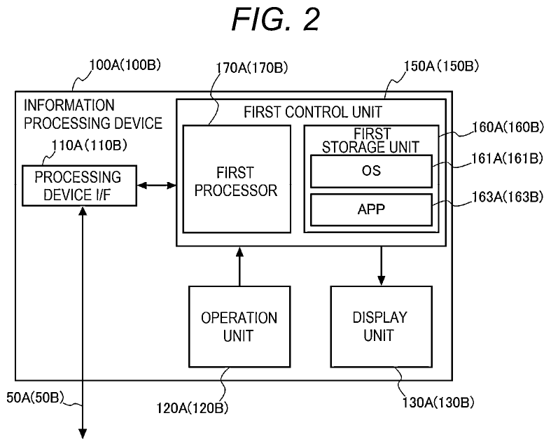

FIG. 2 is a block diagram showing a configuration of the information processing device 100A.

The configuration of the information processing device 100A will be described with reference to FIG. 2. The information processing device 100B has substantially the same configuration as the information processing device 100A. Therefore, the configuration of the information processing device 100A will be described, and a description of the configuration of the information processing device 100B will be omitted. The numbers in parentheses in FIG. 2 indicate the numbers of components included in the information processing device 100B.

The information processing device 100A includes a processing device I/F 110A, an operation unit 120A, a display unit 130A, and a first control unit 150A. Hereinafter, an interface is also referred to as an I/F.

The processing device I/F 110A includes communication hardware such as a connector and an interface circuit conforming to a predetermined communication standard. The processing device I/F 110A transmits and receives image data, control data, and the like to and from the projector 200 according to the predetermined communication standard under the control of the first control unit 150A. As the processing device I/F 110A, for example, an interface capable of digitally transmitting a video and a sound such as HDMI, Displayport, HDBaseT, USB Type-C, or 3G-serial digital interface (SDI) can be used. HDBaseT is a registered trademark. An interface for data communication such as a USB can be used as the processing device I/F 110A.

The operation unit 120A includes an input device such as a mouse and a keyboard, and receives a user operation.

The display unit 130A includes a display panel such as a liquid crystal display or an organic electro-luminescence (EL), and displays an image on the display panel under the control of the first control unit 150A.

The first control unit 150A is a computer device including a first storage unit 160A and a first processor 170A.

The first storage unit 160A includes a random access memory (RAM) and a read only memory (ROM). The first storage unit 160A may include an auxiliary storage device such as a solid state drive (SSD) or a hard disk drive (HDD).

The RAM is used for temporarily storing various kinds of data and the like, and the ROM stores control programs such as an operating system (OS) 161A for controlling the operation of the information processing device 100A and an application program 163A, and various kinds of setting information. The application program 163A is hereinafter referred to as APP 163A.

The first processor 170A is a calculation processing device including a central processing unit (CPU) and a microprocessor unit (MPU). The first processor 170A executes the OS 161A and the APP 163A to control each unit of the information processing device 100A. The first processor 170A may be implemented by a single processor, or may be implemented by a plurality of processors.

### 3. Configuration of Projector in First Embodiment

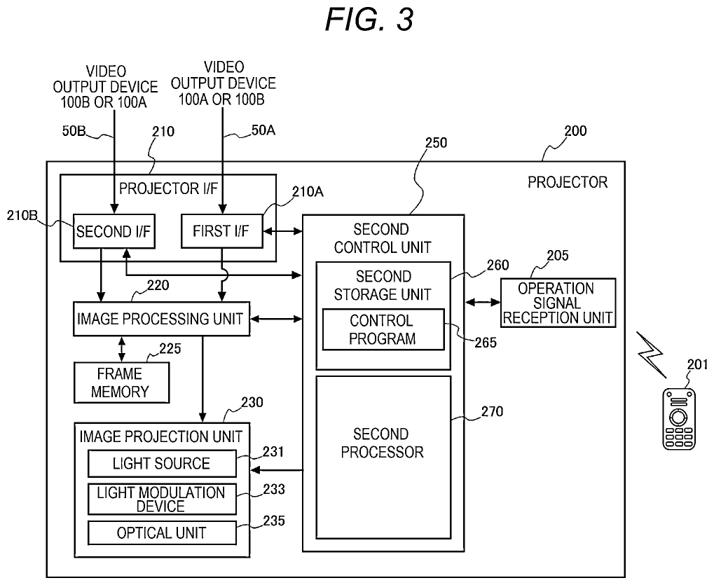

FIG. 3 is a block diagram showing a configuration of the projector 200.

The configuration of the projector 200 is described with reference to FIG. 3.

The projector 200 includes an operation signal reception unit 205, a projector I/F 210, an image processing unit 220, a frame memory 225, an image projection unit 230, and a second control unit 250.

The operation signal reception unit 205 is a receiving device for an infrared signal, and includes a light receiving element, a decoder, and the like (not shown). The operation signal reception unit 205 receives and decodes an infrared signal transmitted from a remote control 201. The operation signal reception unit 205 decodes the infrared signal and outputs, to the second control unit 250, an operation signal corresponding to an operated operation key or button on the remote control 201. The operation signal reception unit 205 may receive a wireless signal such as Bluetooth from the remote control 201. Bluetooth is a registered trademark. When a wireless signal is received, the operation signal reception unit 205 may include an antenna and a reception circuit.

The remote control 201 includes a plurality of operation keys. For example, the remote control 201 includes a menu key for displaying a menu for performing various settings, direction keys corresponding to four directions of up, down, left, and right for selecting items of the menu, and an enter key for determining an operation. The remote control 201 may be a mobile terminal such as a smartphone. In this case, an I/F image of the operation key is displayed on a touch panel of the mobile terminal by application software installed in the mobile terminal.

The projector I/F 210 includes two interfaces of a first I/F 210A and a second I/F 210B. The first I/F 210A corresponds to a first interface, and the second I/F 210B corresponds to a second interface. The number of interfaces included in the projector I/F 210 is not limited to two, and may be three or more. The first I/F 210A and the second I/F 210B are collectively referred to as the projector I/F 210.

The first I/F 210A and the second I/F 210B include communication hardware such as a connector and an interface circuit conforming to a predetermined communication standard. The first I/F 210A and the second I/F 210B transmit and receive image data, control data, and the like to and from the information processing devices 100A and 100B according to the predetermined communication standard under the control of the second control unit 250. As the first I/F 210A and the second I/F 210B, for example, an interface capable of digitally transmitting a video and a sound such as HDMI, Displayport, HDBaseT, USB Type-C, or 3G-serial digital interface (SDI) can also be used. An interface for data communication such as a USB can be used as the first I/F 210A and the second I/F 210B.

The frame memory 225 is coupled to the image processing unit 220. The frame memory 225 includes a plurality of banks. Each bank has a storage capacity capable of writing a display image for one frame. The frame memory 225 includes, for example, a synchronous dynamic RAM (SDRAM). The image processing unit 220 loads the image data input from the first I/F 210A or the second I/F 210B in the frame memory 225.

The image processing unit 220 performs image processing on the image data loaded in the frame memory 225. The image processing performed by the image processing unit 220 includes, for example, resolution conversion processing or resizing processing, distortion correction, shape correction processing, digital zoom processing, and adjustment of image color tone and brightness. The image processing unit 220 executes processing designated by the second control unit 250, and performs the processing using a parameter input from the second control unit 250 as necessary. Of course, the image processing unit 220 can execute a combination of a plurality of kinds of image processing described above.

The image processing unit 220 and the frame memory 225 are implemented by, for example, an integrated circuit. The integrated circuit includes a large scale integration (LSI), an application specific integrated circuit (ASIC), a programmable logic device (PLD), a field-programmable gate array (FPGA), a system-on-a-chip (SoC), and the like. An analog circuit may be included in a part of the configuration of the integrated circuit, and the second control unit 250 and the integrated circuit may be combined.

The image projection unit 230 includes a light source 231, a light modulation device 233, and an optical unit 235. The light source 231, the light modulation device 233, and the optical unit 235 correspond to an optical device.

The light source 231 includes a discharge type light source lamp such as an extra-high pressure mercury lamp or a metal halide lamp, or a solid light source such as a light-emitting diode or a semiconductor laser. Light emitted from the light source 231 is incident on the light modulation device 233.

The light modulation device 233 includes a transmissive liquid crystal panel in which liquid crystal is sealed between a pair of transparent substrates as a light modulation element that modulates light emitted from the light source 231. The liquid crystal panel is not shown. The liquid crystal panel includes a panel region including a plurality of pixels arranged in a matrix. The light modulation device 233 applies a drive voltage corresponding to the image data input from the image processing unit 220 to each pixel of the panel region to change a light transmittance of each pixel to a transmittance corresponding to the display image. Light emitted from the light source 231 is transmitted through the liquid crystal panel to be modulated, and image light corresponding to image data is generated.

A light modulation element included in the light modulation device 233 is not limited to the transmissive liquid crystal panel, and may be, for example, a reflective liquid crystal panel or a digital micromirror device (DMD).

The optical unit 235 includes a projection lens (not shown) and the like, and enlarges and projects the image light modulated by the light modulation device 233 onto the projection surface 10. Accordingly, a display image corresponding to the image light is displayed on the projection surface 10.

The second control unit 250 is a computer device including a second storage unit 260 and a second processor 270.

The second storage unit 260 includes a RAM and a ROM. The RAM is used for temporarily storing various kinds of data and the like, and the ROM stores a control program 265 for controlling the operation of the projector 200, various kinds of setting data and the like.

Setting data stored in the second storage unit 260 includes settings of a primary I/F and a secondary I/F. The primary I/F is an I/F that preferentially receives the image data. The secondary I/F is an I/F that receives the image data instead of the primary I/F when a problem occurs in the primary I/F and the image data cannot be received. In the embodiment, it is assumed that the first I/F 210A is set to the primary I/F and the second I/F 210B is set to the secondary I/F. The first I/F 210A corresponds to a preset interface. The primary I/F corresponds to a main interface.

The user can change the settings of the primary I/F and the secondary I/F by operating the remote control 201. For example, when a user operates the remote control 201 in a state in which the first I/F 210A is set as the primary I/F, the primary I/F is changed from the first I/F 210A to the second I/F 210B.

The setting data stored in the second storage unit 260 includes a projector ID for uniquely identifying the projector 200. The projector ID may be, for example, a serial number of the projector 200, or may be set by the user operating the remote control 201.

The second processor 270 is a calculation processing unit implemented by a CPU or an MPU. The second processor 270 executes a control program to control each unit of the projector 200. The second processor 270 may be implemented by a single processor, or may be implemented by a plurality of processors. The second processor 270 may be implemented by a part or all of the second storage unit 260 or a system-on-a-chip (SoC) integrated with other circuits. The second processor 270 may be implemented by a combination of a CPU that executes a program and digital signal processing (DSP) that executes predetermined calculation processing. Further, all of the functions of the first processors 170A and 170B may be implemented in hardware, or a programmable device may be used.

### 4. Operation of Projector and Information Processing Device in First Embodiment

Next, operations of the information processing device 100 and the projector 200 will be described.

First, the operation of the information processing device 100 will be described. Here, it is assumed that the information processing devices 100A and 100B are coupled to the projector 200 by the cables 50A and 50B.

It is assumed that the information processing device 100A is a primary device coupled to the first I/F 210A which is the primary I/F of the projector 200. It is assumed that the information processing device 100B is a secondary device coupled to the second I/F 210B which is the secondary I/F of the projector 200.

The information processing device 100A which is the primary device supplies the image data to the projector 200 with priority over the information processing device 100B which is the secondary device. The information processing device 100B which is the secondary device supplies the image data to the projector 200 when a problem occurs in the information processing device 100A which is the primary device and the image data cannot be supplied to the projector 200. That is, the information processing device 100B as the secondary device functions as a backup device of the information processing device 100A as the primary device.

The primary I/F is an interface for coupling the primary device, and the secondary I/F is an interface for coupling the secondary device. Generally, the primary I/F is an interface having higher performance than the secondary I/F. For example, when the primary I/F and the secondary I/F are HDMI interfaces, a case in which a version of the primary I/F is HDMI 2.1 and a version of the secondary I/F is HDMI 2.0, and the like are exemplified.

When coupled to the projector I/F 210 of the projector 200, the information processing devices 100A and 100B receive a consumer electronics control (CEC) signal including the projector ID from the projector 200. The information processing devices 100A and 100B can identify the projector 200 to which the information processing devices 100A and 100B are coupled by the projector ID received from the projector 200.

When the information processing device 100A set in the primary device receives the CEC signal including the projector ID, the first control unit 150A transmits, to the projector 200, a CEC request signal including a predetermined CEC command. The predetermined CEC command is, for example, a coupling confirmation command for confirming whether the projector I/F 210 of the projector 200 to which the information processing device 100A is coupled is the primary I/F. The CEC request signal corresponds to a coupling confirmation signal.

Upon receiving the CEC request signal, the second control unit 250 of the projector 200 determines whether the projector I/F 210 that receives the CEC request signal is the primary I/F. In the embodiment, it is assumed that the first I/F 210A is set to the primary I/F and the second I/F 210B is set to the secondary I/F.

When the projector I/F 210 that receives the CEC request signal is the first I/F 210A that is the primary I/F, the second control unit 250 transmits a CEC response signal via the first I/F 210A. The CEC response signal includes the projector ID. The CEC response signal corresponds to a first response signal.

When the projector I/F 210 that receives the CEC request signal is the second I/F 210B that is the secondary I/F, the second control unit 250 prohibits transmission of the CEC response signal. That is, the second control unit 250 does not transmit the CEC response signal to the second I/F 210B which is the secondary I/F.

Upon receiving the CEC response signal from the projector 200, the information processing device 100A determines that the information processing device 100A as the primary device is coupled to the first I/F 210A as the primary I/F.

When the CEC response signal is not received from the projector 200, the information processing device 100A determines that the information processing device 100A as the primary device is not coupled to the first I/F 210A as the primary I/F.

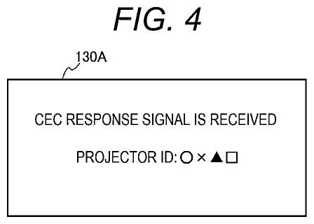

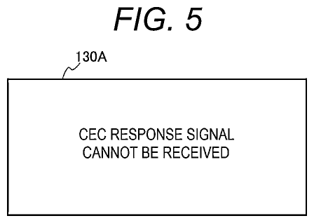

FIGS. 4 and 5 are diagrams showing examples of guidane images displayed on the display unit 130A.

FIG. 4 shows the guidane image displayed on the display unit 130A when the CEC response signal is received from the projector 200, and FIG. 5 shows the guidane image displayed on the display unit 130A when the CEC response signal is not received from the projector 200.

As shown in FIG. 4, when the CEC response signal is received from the projector 200, the first control unit 150A causes the display unit 130A to display that the CEC response signal is received and the projector ID included in the received CEC signal. The user can confirm that the information processing device 100A as the primary device is coupled to the primary I/F of the projector 200 by visually recognizing the display.

As shown in FIG. 5, when the CEC response signal is not received from the projector 200, the first control unit 150A causes the display unit 130A to display that the CEC response signal cannot be received. The user can confirm that the information processing device 100A as the primary device is not coupled to the primary I/F of the projector 200 by visually recognizing the display.

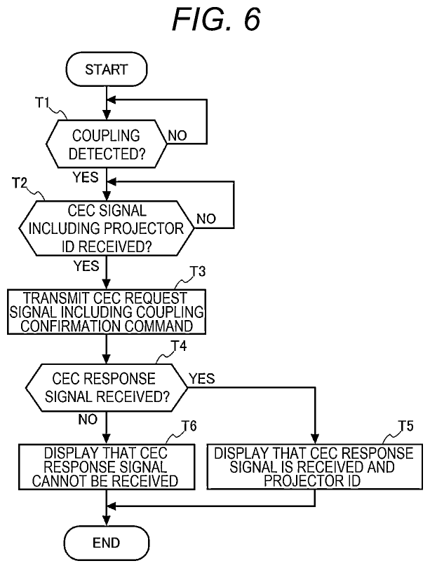

FIG. 6 is a flowchart showing the operation of the information processing device 100A.

The operation of the information processing device 100A will be described with reference to the flowchart shown in FIG. 6.

First, the first control unit 150A determines whether coupling to the processing device I/F 110A is detected (step T1). When the coupling to the processing device I/F 110A is not detected (step T1/NO), the first control unit 150A waits until the coupling to the processing device I/F 110A is detected.

When the coupling to the processing device I/F 110A is detected (step T1/YES), the first control unit 150A determines whether a CEC signal including the projector ID is received from the projector 200 (step T2). When the CEC signal including the projector ID is not received (step T2/NO), the first control unit 150A waits until the CEC signal including the projector ID is received.

When the CEC signal including the projector ID is received (step T2/YES), the first control unit 150A transmits a CEC request signal including a coupling confirmation command to the projector 200 (step T3).

Next, the first control unit 150A determines whether the CEC response signal is received from the projector 200 (step T4). When the CEC response signal is received from the projector 200 (step T4/YES), the first control unit 150A displays that the CEC response signal is received and the projector ID on the display unit 130A (step T5). When the CEC response signal cannot be received from the projector 200 even after a preset setting time elapses (step T4/NO), the first control unit 150A causes the display unit 130A to display that the CEC response signal cannot be received (step T6).

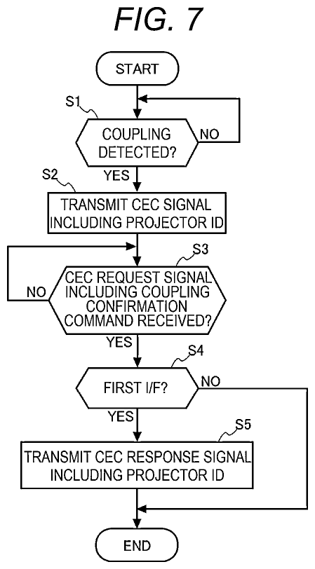

FIG. 7 is a flowchart showing the operation of the projector 200 according to the first embodiment.

The operation of the projector 200 will be described with reference to the flowchart shown in FIG. 7.

First, the second control unit 250 determines whether coupling to the projector I/F 210 is detected (step S1). When the coupling to the projector I/F 210 is not detected (step S1/NO), the second control unit 250 waits until the coupling to the projector I/F 210 is detected.

When the coupling to the projector I/F 210 is detected (step S1/YES), the second control unit 250 transmits a CEC signal including the projector ID via the projector I/F 210 in which the coupling is detected (step S2).

Next, the second control unit 250 determines whether a CEC request signal including a coupling confirmation command is received (step S3). When the CEC request signal including the coupling confirmation command is not received (step S3/NO), the second control unit 250 waits until the CEC request signal including the coupling confirmation command is received.

Upon receiving the CEC request signal including the coupling confirmation command (step S3/YES), the second control unit 250 determines whether the projector I/F 210 that receives the CEC request signal is the first I/F 210A (step S4).

When the projector I/F 210 that receives the CEC request signal is not the first I/F 210A (step S4/NO), the second control unit 250 ends the processing flow without transmitting the CEC response signal, and returns to the determination of step S1.

When the projector I/F 210 that receives the CEC request signal is the first I/F 210A (step S4/YES), the second control unit 250 transmits the CEC response signal via the first I/F 210A (step S5). The CEC response signal includes the projector ID.

### 5. Second Embodiment

Next, a second embodiment will be described with reference to the accompanying drawings.

Since the configurations of the information processing device 100 and the projector 200 according to the second embodiment are the same as the configurations of the information processing device 100 and the projector 200 according to the first embodiment shown in FIGS. 2 and 3, the same reference numerals are given to the same configurations, and the description of the configurations of the information processing device 100 and the projector 200 will be omitted.

In the first embodiment described above, the second control unit 250 transmits the CEC response signal via the first I/F 210A only when the projector I/F 210 that receives the CEC request signal including the coupling confirmation command is the first I/F 210A that is the primary I/F. The CEC response signal includes the projector ID.

In the second embodiment, the second control unit 250 transmits the CEC response signal even when the projector I/F 210 that receives the CEC request signal including the coupling confirmation command is the secondary I/F. In the second embodiment, information to be included in the CEC response signal is changed. When the CEC request signal is received by the first I/F 210A, the second control unit 250 transmits the CEC response signal including information indicating that the projector I/F 210 that receives the CEC request signal is the primary I/F via the first I/F 210A. The CEC response signal is referred to as a first CEC response signal.

When the CEC request signal is received by the second I/F 210B, the second control unit 250 transmits the CEC response signal including information indicating that the projector I/F 210 that receives the CEC request signal is the secondary I/F via the second I/F 210B. The CEC response signal is referred to as a second CEC response signal. The second CEC response signal corresponds to a second response signal.

That is, the CEC response signal according to the second embodiment includes the projector ID and the information indicating the projector I/F 210 that receives the CEC request signal.

In the second embodiment, in addition to the primary I/F, when the second I/F 210B as the secondary I/F receives the CEC request signal, the second CEC response signal is also transmitted via the second I/F 210B. Therefore, it is also possible to determine whether the projector I/F 210 of the projector 200 to which the information processing device 100 is coupled is the second I/F 210B.

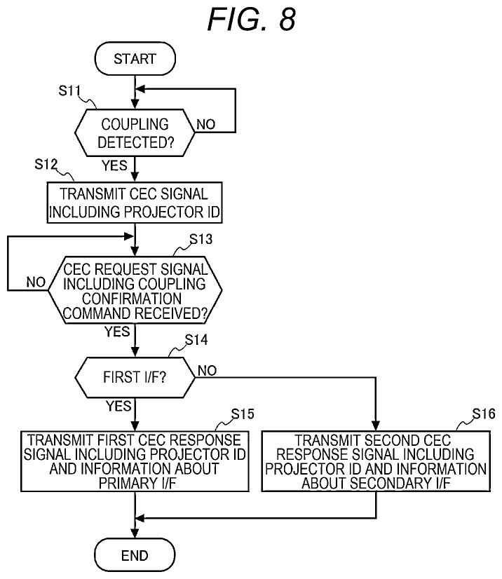

FIG. 8 is a flowchart showing the operation of the projector 200 according to the second embodiment.

The operation of the projector 200 will be described with reference to the flowchart shown in FIG. 8. Since the operations of steps S11 to S14 of the flowchart shown in FIG. 8 are the same as steps S1 to S4 of the flowchart shown in FIG. 7, a description thereof will be omitted.

The second control unit 250 determines whether the projector I/F 210 that receives the CEC request signal including the coupling confirmation command is the first I/F 210A (step S14). When the projector I/F 210 that receives the CEC request signal is the first I/F 210A (step S14/YES), the second control unit 250 transmits the first CEC response signal via the first I/F 210A.

When the projector I/F 210 that receives the CEC request signal is the second I/F 210B (step S14/NO), the second control unit 250 transmits the second CEC response signal via the second I/F 210B.

Although FIG. 2 shows an example in which the information processing device 100A includes one processing device I/F 110A, for example, it is assumed that the information processing device 100A includes two processing device I/Fs 110A.

In addition, it is assumed that the user erroneously couples the two processing device I/Fs 110A of the information processing device 100A to the first I/F 210A and the second I/F 210B of the projector 200, respectively.

The first control unit 150A transmits the CEC request signal via each of the two processing device I/Fs 110A. Accordingly, the information processing device 100A receives the first CEC response signal and the second CEC response signal from the projector 200. The first control unit 150A causes the display unit 130A to display the projector ID included in the received first CEC response signal and second CEC response signal. Accordingly, the user can recognize that the two processing device I/Fs 110A of the information processing device 100A are coupled to the same projector 200.

### 6. Third Embodiment

Next, a third embodiment will be described with reference to the accompanying drawings.

Since the configurations of the information processing device 100 and the projector 200 according to the third embodiment are the same as the configurations of the information processing device 100 and the projector 200 according to the first embodiment shown in FIGS. 2 and 3, the same reference numerals are given to the same configurations, and the description of the configurations of the information processing device 100 and the projector 200 will be omitted.

In the third embodiment, when the information processing device 100A as the primary device cannot receive the CEC response signal from the projector 200, the information processing device 100B as the secondary device transmits the CEC request signal to the projector 200.

The information processing device 100A which is the primary device transmits the CEC request signal to the projector 200 in response to reception of the CEC signal including the projector ID from the projector 200.

For example, when a predetermined operation is received by an operation unit 120B, the information processing device 100B which is the secondary device transmits the CEC request signal to the projector 200. The predetermined operation is, for example, an operation of a button or the like provided in the operation unit 120B.

The information processing device 100A and the information processing device 100B may be coupled via a network, and the information processing device 100A may notify the information processing device 100B that the CEC response signal cannot be received from the projector 200. When a notification that the CEC response signal cannot be received is received from the projector 200, the information processing device 100B transmits the CEC request signal to the projector 200.

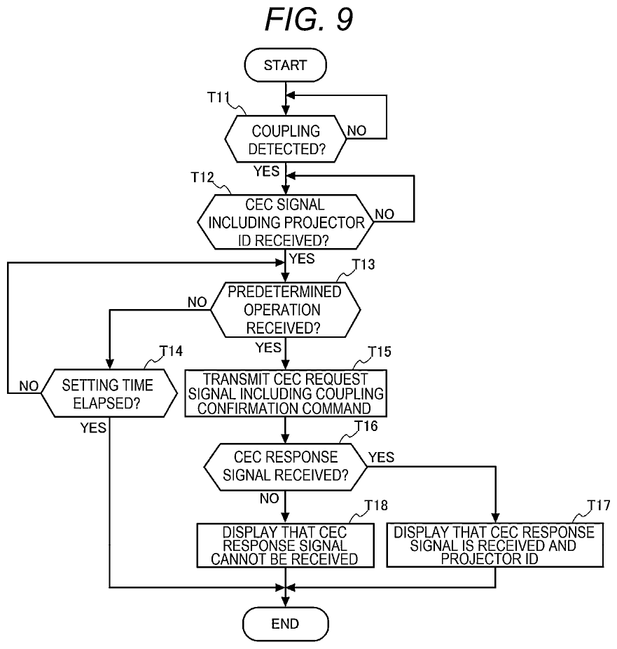

Next, the operation of the information processing device 100B according to the third embodiment will be described with reference to the flowchart shown in FIG. 9.

The operation of the information processing device 100A in the third embodiment is the same as the operation of the information processing device 100A in the first embodiment shown in FIG. 6, and the operation of the projector 200 in the third embodiment is the same as the operation of the projector 200 in the first embodiment shown in FIG. 7. Therefore, the description of the operations of the projector 200 and the information processing device 100A will be omitted.

A first control unit 150B determines whether a coupling to the processing device I/F 110B is detected (step T11). When the coupling to a processing device I/F 110B is not detected (step T11/NO), the first control unit 150B waits until the coupling to the processing device I/F 110B is detected.

When the coupling to the processing device I/F 110B is detected (step T11/YES), the first control unit 150B determines whether a CEC signal including the projector ID is received from the projector (step T12). When the CEC signal including the projector ID is not received (step T12/NO), the first control unit 150B waits until the CEC signal including the projector ID is received.

When the CEC signal including the projector ID is received (step T2/YES), the first control unit 150B determines whether a predetermined operation is received from the operation unit 120B (step T13). When the predetermined operation is not received (step T13/NO), the first control unit 150B determines whether an elapsed time from the reception of the CEC signal in step T12 exceeds a preset setting time (step T14).

When the elapsed time from the reception of the CEC signal at step T12 exceeds the preset setting time (step T14/YES), the first control unit 150B ends the processing flow.

When the elapsed time from the reception of the CEC signal at step T12 does not exceed the preset setting time (step T14/NO), the first control unit 150B returns to the determination at step T13.

Upon receiving the predetermined operation (step T13/YES), the first control unit 150B transmits the CEC request signal including the coupling confirmation command to the projector 200 (step T15).

Next, the first control unit 150B determines whether the CEC response signal is received from the projector 200 (step T16). When the CEC response signal is received from the projector 200 (step T16/YES), the first control unit 150B displays that the CEC response signal is received and the projector ID on the display unit 130A (step T17). When the CEC response signal cannot be received from the projector 200 even after a preset setting time elapses (step T16/NO), the first control unit 150A causes the display unit 130A to display that the CEC response signal cannot be received (step T18).

### 7. Fourth Embodiment

Next, a fourth embodiment will be described with reference to the accompanying drawings.

The configurations of the information processing device 100 and the projector 200 according to the fourth embodiment are the same as the configurations of the information processing device 100 and the projector 200 according to the first embodiment shown in FIGS. 2 and 3, and thus a detailed description thereof will be omitted.

In the first to third embodiments described above, when the projector 200 receives the CEC request signal, the projector 200 transmits the CEC response signal via the projector I/F 210 that receives the CEC response signal.

In the fourth embodiment, the second control unit 250 executes a notification operation when the projector I/F 210 that receives the CEC request signal is not the first I/F 210A set as the primary I/F.

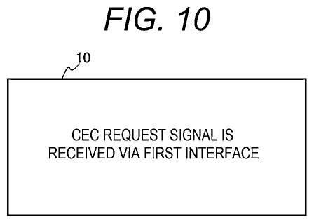

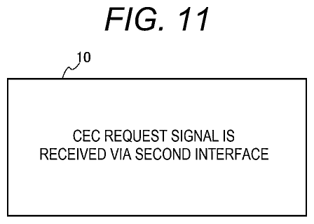

Examples of the notification operation executed by the projector 200 include sending a mail to a preset mail address and lighting or blinking an LED lamp or the like provided in the projector 200. In addition, in the notification operation, when the projector 200 includes a speaker, a sound for notifying a preset error may be output from the speaker. The guidane images displayed on the display unit 130A of the information processing device 100A shown in FIGS. 4 and 5 may be displayed on the projection surface 10 by the projector 200. FIG. 10 shows a guidane image to be displayed on the projection surface 10 when the CEC request signal is received by the first I/F 210A. FIG. 11 shows a guidane image to be displayed on the projection surface 10 when the CEC request signal is received by the second I/F 210B. The second I/F 210B corresponds to an interface other than the preset interface. The guidane image shown in FIG. 11 corresponds to a preset image.

The projector 200 may display whether the primary device is coupled to the primary I/F by changing a display color of the guidane image to be displayed on the projection surface 10 or the image itself to be displayed as the guidane image.

For example, when the projector I/F 210 that receives the CEC request signal is the primary I/F, the second control unit 250 displays a display image of a first color on the projection surface 10. When the projector I/F 210 that receives the CEC request signal is the secondary I/F, the second control unit 250 displays a display image of a second color on the projection surface 10. The second color is set to a color different from the first color.

### 8. Other Embodiments

The above described embodiments are preferred embodiments of the present disclosure. However, the present disclosure is not limited to the embodiments described above and various modified implementations are possible within a range not departing from the gist of the present disclosure.

For example, in Embodiments 1, 2, and 3 described above, although the projector 200 is described as an example of the display device, the display device may be a flat panel display.

In the flowchart shown in FIG. 7, when the coupling to the projector I/F 210 is detected in step S1, the projector 200 transmits the CEC signal including the projector ID to the projector I/F 210 whose coupling is detected in step S2. However, the projector 200 may display the projector ID on the projection surface 10 after transmitting the CEC signal including the projector ID in step S5 without transmitting the CEC signal including the projector ID. The user can confirm the projector 200 to which the information processing device 100A is coupled by comparing the projector ID displayed on the display unit 130A of the information processing device 100A with the projector ID displayed on the projection surface 10.

For example, the configuration of the information processing device 100A shown in FIG. 2 and the configuration of the projector 200 shown in FIG. 3 show functional configurations, and a specific implementation form is not particularly limited. That is, it is needless to say that hardware corresponding to each functional unit is not necessarily implemented, and functions of a plurality of functional units may be implemented with one processor executing a program. In the above-described embodiments, a part of functions implemented by software may be implemented by hardware, or a part of functions implemented by hardware may be implemented by software. In addition, specific detailed configurations of the other units of the information processing device 100 and the projector 200 can be also freely changed without departing from the gist of the present disclosure.

Processing units of the flowcharts shown in FIGS. 6 and 9 are divided according to main processing contents to facilitate understanding of the processing of the information processing device 100. The present disclosure is not limited by the way and name of dividing the processing unit shown in the flowcharts of FIGS. 6 and 9. In addition, the processing of the first control unit 150A and the processing of the first control unit 150B may be divided into more processing units according to the processing content, or may be divided such that one processing unit includes more processing. A processing order of the flowchart is not limited to the shown examples.

Similarly, the processing units of the flowcharts shown in FIGS. 7 and 8 are divided according to the main processing content in order to facilitate understanding of the processing of the projector 200. The present disclosure is not limited by the way and name of dividing the processing unit shown in the flowcharts of FIGS. 7 and 8. In addition, the processing of the second control unit 250 may be divided into more processing units according to the processing content, or may be divided such that one processing unit includes more processing. A processing order of the flowchart described above as well is not limited to the shown examples.

When the coupling state detection method is implemented using a computer included in the information processing device 100 and the projector 200, a program to be implemented by the computer may be implemented in a form of a recording medium. Alternatively, the programs to be executed by the computers can also be implemented in a form of a transmission medium for transmitting the programs. As the recording medium, a magnetic or optical recording medium or a semiconductor memory device can be used. Specific examples of the recording medium include portable and stationary recording media such as a flexible disc, an HDD, a CD-ROM, a digital versatile disc (DVD), a Blu-ray disc, a magneto-optical disc, a flash memory, and a card type recording medium. The recording medium may be a nonvolatile storage device such as a RAM, a ROM, or an HDD that is an internal storage device provided in a server device. Blu-ray is a registered trademark.

### 9. Summary of Present Disclosure

The present disclosure will be summarized below in the form of appendixes.

### APPENDIX 1

A coupling state detection method includes: when a coupling confirmation signal from an image output device coupled to a display device including a first interface and a second interface is received via a preset interface among the first interface and the second interface, transmitting a first response signal from the preset interface.

Accordingly, when the interface that receives the coupling confirmation signal from the image output device is the preset interface, the first response signal is transmitted by the display device via the preset interface. Therefore, it is possible for the image output device to determine whether the interface of the display device to which the image output device is coupled is a preset interface. Therefore, it is possible to reduce a work load of confirming the coupling between the image output device and the display device and to improve efficiency of a coupling work between the image output device and the display device.

### APPENDIX 2

In the coupling state detection method according to Appendix 1, the first interface is the preset interface and is a main interface that receives image data with priority over the second interface.

Accordingly, when the coupling confirmation signal is received from the first interface set as the main interface, the first response signal is transmitted to the display device via the first interface. Therefore, it is possible to determine whether the interface of the display device to which the image output device is coupled is the first interface set as the main interface. In addition, it is possible to determine whether the first interface set as the main interface and the image output device can normally communicate.

### APPENDIX 3

The coupling state detection method according to Appendix 1 or 2, further includes: transmitting a second response signal from the second interface when the coupling confirmation signal is received via the second interface.

Accordingly, when the display device receives the coupling confirmation signal via the second interface different from the first interface which is the preset interface, the second response signal is transmitted via the second interface. Therefore, it is also possible to determine whether the interface of the display device to which the image output device is coupled is the second interface.

When the image output device cannot receive the first response signal and the second response signal, it can be determined that a display device main body fails. When the image output device receives the first response signal or the second response signal, it can be determined that the first interface fails or that the cable coupling the display device and the image output device is broken.

### APPENDIX 4

The coupling state detection method according to any one of Appendices 1 to 3 further includes: executing a notification operation by the display device when the coupling confirmation signal is received from an interface other than the preset interface among the first interface and the second interface.

Accordingly, when the coupling confirmation signal is received via the interface other than the preset interface, the notification operation is executed by the display device. Therefore, it is possible to confirm, by the notification operation executed by the display device, that the interface of the display device to which the image output device is coupled is not the preset interface.

### APPENDIX 5

In the coupling state detection method according to Appendix 4, the executing the notification operation by the display device includes displaying a preset image by the display device.

Accordingly, when the coupling confirmation signal is received via the interface other than the preset interface, the preset image is displayed by the display device. Therefore, it is possible to confirm that the interface of the display device to which the image output device is coupled is not the preset interface by visually recognizing the preset image displayed by the display device.

### APPENDIX 6

In the coupling state detection method according to any one of Appendices 1 to 3, the transmission of the first response signal by the display device is prohibited when an interface that receives the coupling confirmation signal is not the preset interface.

Accordingly, when the interface that receives the coupling confirmation signal is not the preset interface, the transmission of the first response signal by the display device is prohibited. Therefore, the image output device can determine whether the interface of the display device to which the image output device is coupled is the preset interface depending on whether the first response signal is received. Therefore, it is possible to reduce a work load of confirming the coupling between the image output device and the display device and to improve efficiency of a coupling work between the image output device and the display device.

### APPENDIX 7

The coupling state detection method according to any one of Appendices 1 to 6 further includes: receiving selection of an interface to be set as a main interface among the first interface and the second interface.

Accordingly, the main interface can be selected from the first interface and the second interface. Therefore, the interface for confirming the coupling between the image output device and the display device can be selected, and a work load can be further reduced.

### APPENDIX 8

A display system includes: a display device including a first interface and a second interface; and a first image output device coupled to the display device and configured to transmit a coupling confirmation signal to the display device. When the coupling confirmation signal is received from a preset interface among the first interface and the second interface, the display device transmits a first response signal from the preset interface.

According to such a configuration, when the interface that receives the coupling confirmation signal from the first image output device is the preset interface, the first response signal is transmitted by the display device via the preset interface. Therefore, it is possible for the first image output device to determine whether the interface of the display device to which the first image output device is coupled is a preset interface. Therefore, it is possible to reduce a work load of confirming the coupling between the first image output device and the display device and to improve efficiency of a coupling work between the first image output device and the display device.

### APPENDIX 9

The display system according to Appendix 8 further includes: a second image output device coupled to the display device. The coupling confirmation signal is transmitted by the second image output device when the first image output device does not receive the first response signal from the display device, and the first response signal is transmitted by the display device via the preset interface when the coupling confirmation signal from the second image output device is received via the preset interface.

According to such a configuration, when the first image output device does not receive the first response signal from the display device, the coupling confirmation signal is transmitted to the display device by the second image output device. When the coupling confirmation signal from the second image output device is received via the preset interface of the display device, the first response signal is transmitted via the preset interface. Therefore, by confirming whether the image output device that receives the first response signal is the first image output device or the second image output device, the image output device coupled to the preset interface can be confirmed. Therefore, it is possible to reduce a work load of confirming the coupling between the first and second image output devices and the display device and to improve efficiency of a coupling work between the first and second image output devices and the display device.

### APPENDIX 10

A display device includes: a first interface and a second interface; and at least one processor. When a coupling confirmation signal is received via a preset interface among the first interface and the second interface, the at least one processor transmits a first response signal via the preset interface.

Accordingly, when the interface that receives the coupling confirmation signal from the image output device is the preset interface, the first response signal is transmitted by the display device via the preset interface. Therefore, it is possible for the image output device to determine whether the interface of the display device to which the image output device is coupled is a preset interface. Therefore, it is possible to reduce a work load of confirming the coupling between the image output device and the display device and to improve efficiency of a coupling work between the image output device and the display device.

What is claimed is:

1. A coupling state detection method comprising:
when a coupling confirmation signal from an image output device coupled to a display device including a first interface and a second interface is received via a preset interface among the first interface and the second interface, transmitting a first response signal from the preset interface.

2. The coupling state detection method according to claim 1, wherein
the first interface is the preset interface and is a main interface that receives image data with priority over the second interface.

3. The coupling state detection method according to claim 1, further comprising:
transmitting a second response signal from the second interface when the coupling confirmation signal is received via the second interface.

4. The coupling state detection method according to claim 1, further comprising:
executing a notification operation by the display device when the coupling confirmation signal is received from an interface other than the preset interface among the first interface and the second interface.

5. The coupling state detection method according to claim 4, wherein
the executing the notification operation by the display device includes displaying a preset image by the display device.

6. The coupling state detection method according to claim 1, wherein
the transmission of the first response signal by the display device is prohibited when an interface that receives the coupling confirmation signal is not the preset interface.

7. The coupling state detection method according to claim 2, further comprising:
receiving selection of an interface to be set as a main interface among the first interface and the second interface.

8. A display system comprising:
a display device including a first interface and a second interface; and
a first image output device coupled to the display device and configured to transmit a coupling confirmation signal to the display device, wherein
when the coupling confirmation signal is received from a preset interface among the first interface and the second interface, the display device transmits a first response signal from the preset interface.

9. The display system according to claim 8, further comprising:
a second image output device coupled to the display device, wherein
the coupling confirmation signal is transmitted by the second image output device when the first image output device does not receive the first response signal from the display device, and
the first response signal is transmitted by the display device via the preset interface when the coupling confirmation signal from the second image output device is received via the preset interface.

10. A display device comprising:
a first interface and a second interface; and
at least one processor, wherein
when a coupling confirmation signal is received via a preset interface among the first interface and the second interface, the at least one processor transmits a first response signal via the preset interface.
